(19) United States
(12) Patent Application Publication
(10) Pub. No.: US 2009/0296014 A1
(43) Pub. Date: Dec. 3, 2009

(54) Touch Panel Display Device

(75) Inventors: Chi-Ming Tseng, Taipei Hsien (TW); Shih-Chuan Li, Taipei Hsien (TW); Chang-Ting Ho, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/129,498

(22) Filed: May 29, 2008

(51) Int. Cl. G02F 1/1333

(52) U.S. Cl. 349/58

(57) ABSTRACT

A touch panel display device has a touch panel and a liquid crystal module. The liquid crystal module has a frame and a liquid crystal panel positioned in the frame. The frame has a top surface formed as a rectangular rim shape. The frame has a first arm and a second arm projected from two adjacent edges of the top surface respectively. While the touch panel is adhered on the top surface of the frame, two adjacent edges of the touch panel are against the first arm and the second arm respectively. Therefore, the touch panel is aligned with the liquid crystal module and adhered on the top surface of the frame of the liquid crystal module without an extra tool for more convenience and accuracy of assembling the touch panel display device.

### BACKGROUND OF THE INVENTION

1. Field of the Invention

The present invention relates to a touch panel display device and, more particularly, to a touch panel displace device convenient to be assembled with a liquid crystal module.

2. The Related Art

Nowadays, electrical digital products, such as, mobile phones, personal digital assistants (PDAs), cameras, are more and more popular on the marketplace due to multiple functions and easy operations of the digital products. An example for easy operation of a digital product is that many mobile phones are adopting touch panel screens which allow a user to touch an area of a display screen to provide a command to the mobile phone system associated with the display screen, and hence control the operation of the mobile phone. A touch screen has functions as the input interface and the output interface of the electrical devices.

Usually, a touch panel screen is assembled with a liquid crystal module to perform the operation function. The liquid crystal module functions as an output interface and the touch panel functions as an input interface. The liquid crystal module converts electrical signal to information and then displays the information such as figures and texts. The touch panel of the touch screen senses touching positions or touching tracks and then converts the touching position or the touching tracks to electrical signal as function as input signal.

As is known, the touch panel is usually adhered to the liquid crystal module by adhesive. While the touch panel is adhered to the liquid crystal module, the touch panel needs to align with the liquid crystal module by an extra tool or a special apparatus. Apparently, it is not convenient for the assembly of the touch penal screen device having to resort to an extra tool. In addition, it is also difficult for the touch panel to align with the liquid crystal module during the assembly.

### SUMMARY OF THE INVENTION

An object of the present invention is to provide a touch panel display device having a first frame, a second frame, a third frame, a liquid crystal panel and a touch panel.

The second frame is adapted to receive the liquid crystal panel. The third frame defines a space to receive the second frame and the liquid crystal panel, and is adapted for engaging with the first frame. The first frame includes a plurality of side walls and an aligning means. The first frame is configured to align the touch panel with the first frame by the aligning means of at least one protruding element formed on each one of at least two adjacent side walls of the first frame.

While the touch panel is fixed to the first frame, two adjacent edges of the touch panel abut against the protruding elements respectively. Therefore, the touch panel is convenient to align with the liquid crystal panel without an extra tool or a special apparatus.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view showing a touch panel display device according to the present invention; and

FIG. 2 is a perspective view showing the touch panel display device according to the present invention.

### DETAILED DESCRIPTION OF THE PREFERRED EMBODIMENT

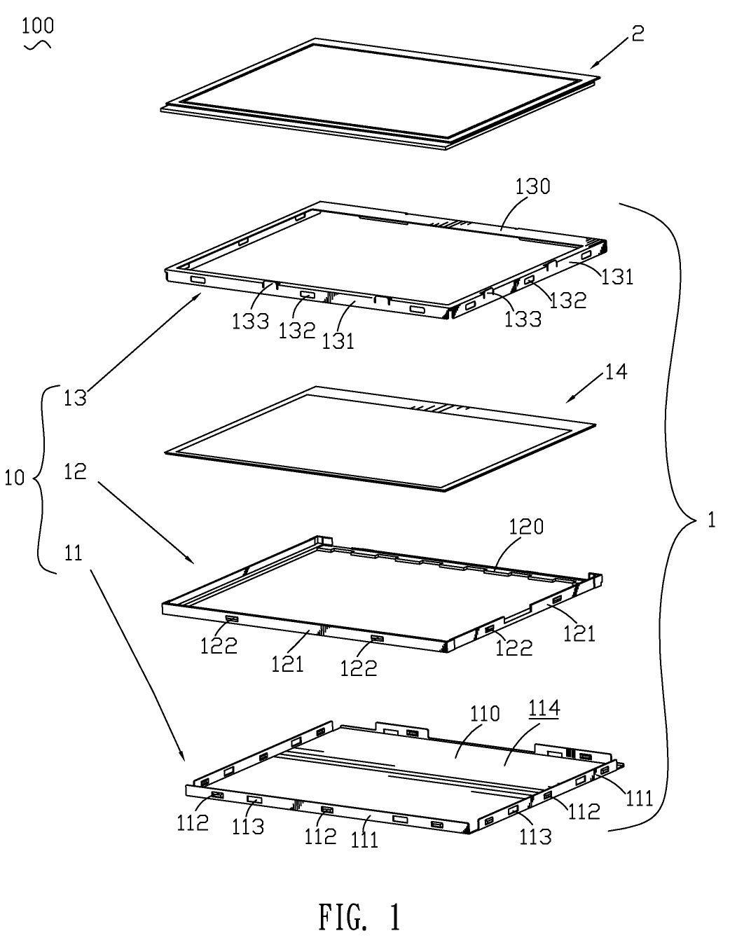

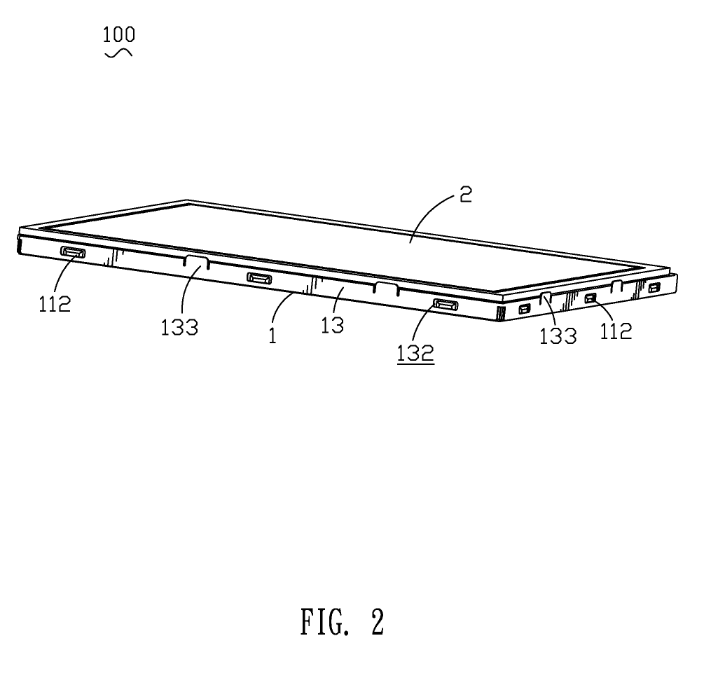

Please refer to FIG. 1 and FIG. 2, an exemplary embodiment of a touch panel display device 100 is shown. The touch panel display device 100 has a liquid crystal module 1 and a touch panel 2. The liquid crystal module 1 has a frame module 10 and a liquid crystal panel 14.

The frame module 10 has a base frame 11, a middle frame 12, and an upper frame 13. Specifically, the middle frame 12 is positioned between the base frame 11 and the upper frame 13. The liquid crystal panel 14 is fixed within the middle frame 12. The upper frame 13 is assembled with the base frames 11 to receive the middle frame 12 and the liquid crystal panel 14. The touch panel 2 is fixed to the upper frame 13.

The base frame 11 has a base plate 110 in a rectangular shape, a plurality of first walls 111 perpendicularly extending from the edges of the base plate 110, a plurality of first projections 112 extending outwardly from the first walls 111 respectively, and a plurality of first holes 113 penetrating into the first walls 111 respectively. The base plate 110 and the first walls 111 define a receiving space 114. Each hole 113 is located between two first projections 112.

The middle frame 12 is received in the receiving space 114 of the base frame 11. The middle frame 12 includes a first rim 120 in a rectangular shape, a plurality of second walls 121 perpendicularly extending from the outer edges of the first rim 120 and a plurality of second projections 122 extending outwardly from the second walls 121, respectively. The first rim 120 is formed as a flat shape. The second projections 122 are used for engaging with the first holes 113 of the base frame 11 respectively. Both the first walls 111 of the base frame 11 and the second walls 121 of the middle frame 12 extend upwardly.

The liquid crystal panel 14 is fixed within the middle frame 12. More specifically, the liquid crystal panel 14 is positioned on the first rim 120 and adhered onto the first rim 120 by adhesive tape.

The upper frame 13 has a second rim 130 in a rectangular shape, a plurality of third walls 131 perpendicularly extending from the outer edges of the second rim 130, a plurality of second holes 132 penetrating into the third walls 131 respectively.

The first projections 112 of the base frame 11 are used for engaging with the second holes 132 of the upper frame 13, respectively. The third walls 131 of the upper frame 13 extend downwardly and cover the outer surface of the first walls 111 of the base frame 11.

The upper frame 13 has a plurality of arms 133 protruding from two adjacent outer edges of the second rim 130. More specifically, the arms 133 extend upwardly from the third walls 131. The touch panel 2 is formed as a rectangular shape. Because two adjacent edges of the touch panel 2 abut against the arms 133 of the upper frame 13, the touch panel 2 is aligned with the upper frame 13 of the liquid crystal module 1.

The touch panel 2 is adhered onto the second rim 130 of the upper frame 13 by adhesive tape. Therefore, the touch panel 2 is adhered to the liquid crystal module 1 and aligned with the liquid crystal module 1 via the arms 133 of the upper frame 13 of the frame module 10. Apparently, it is convenient for the assembly of the touch penal display device 100 without an extra tool or a special apparatus.

Furthermore, the present invention is not limited to the embodiments described above; various additions, alterations and the like may be made within the scope of the present invention by a person skilled in the art. For example, respective embodiments may be appropriately combined.

What is claimed is:

1. A touch panel display device, comprising:
a base frame having a plurality of first side walls and a first engaging means formed on said first side walls;
an upper frame having a first rim, a plurality of second side walls perpendicularly extending downwardly from said first rim, a second engaging means formed on said second side walls for engaging with said first engaging means of said base frame, and at least two arms perpendicularly extending substantially upwardly from second side walls;
a liquid crystal panel positioned between said base frame and said upper frame; and
a touch panel connected with and aligned with said upper frame by pressing against said arms of said upper frame.

2. The touch panel display device as claimed in claim 1, wherein said base frame and said upper frame are formed in a rectangular shape, said base frame has a base plate in a rectangular shape, said first side walls perpendicularly extending from the edges of said base plate, said first side walls of said base frame and said second side walls of said upper frame extending in opposite directions, said first side walls and said base plate defines a receiving space for receiving said liquid crystal panel.

3. The touch panel display device as claimed in claim 2, further comprising a middle frame received in said receiving space, having a second rim formed in a rectangular shape, a plurality of third side walls extending from the outer edges of said second rim and a third engaging means formed on said third side walls for engaging with said first engaging means of said base frame.

4. The touch panel display device as claimed in claim 3, wherein said liquid crystal panel is fixed onto said second rim of said middle frame.

5. The touch panel display device as claimed in claim 3, wherein said touch panel is fixed onto said first rim of said upper frame.

6. The touch panel display device as claimed in claim 3, wherein said first engaging means has first projections extendingly outwardly from said first side walls respectively and first holes penetrating into said first side walls respectively, said second engaging means has second holes penetrating into said second side walls and engaged with said first projections of said first engaging means respectively, said third engaging means has second projections extendingly outwardly from said third side walls and engaged with said first holes of said first engaging means respectively.

7. The touch panel display device as claimed in claim 6, wherein said third side walls of said middle frame are positioned between said first side walls of said base frame and said second side walls of said upper frame respectively.

8. The touch panel display device as claimed in claim 6, wherein said first rim of said upper frame and said second rim of said middle frame are formed as a flat shape when in assembly.

9. A touch panel display device, comprising:
a base frame having
a base plate having a first edge and a second edge connected to said first edge,
a first wall perpendicularly extending from said first edge, and
a second wall perpendicularly extending from said second edge;
an upper frame coupled to said base frame, having
a first rim defining a first outer edge corresponding to said first edge of base plate of said base frame, and a second outer edge connected to said first outer edge and corresponding to said second edge of said base plate of said base frame,
a third wall perpendicularly extending from said first outer edge,
a fourth wall perpendicularly extending from said second outer edge, said third wall and said fourth wall extending in a direction opposite to the direction in which said first and second walls extend,
a first arm perpendicularly projected from said first outer edge of said first rim,
a second arm perpendicularly projected from said second outer edge of said first rim, said first and second arms extending in a direction opposite to the direction in which said third and fourth walls extend;
a liquid crystal panel positioned between said base frame and said upper frame; and
a touch panel positioned on said upper frame and having
a third edge against the inner surface of said first arm of said upper frame,
a fourth edge connected to said third edge and against the inner surface of said second arm of said upper frame.

10. The touch panel display device as claimed in claim 9, further comprising a middle frame received between said base frame and said upper frame, having
a second rim including
a third outer edge corresponding to said first edge of said base plate of said base frame and said first outer edge of said first rim of said upper frame, and
a fourth outer edge corresponding to said second edge of said base plate of said base frame and said second outer edge of said first rim of said upper frame, and connected to said third outer edge, said liquid crystal panel positioned on said second rim,
a fifth wall perpendicularly extended from said third outer edge of said second rim, and
a sixth wall perpendicularly extended from said fourth outer edge of said second rim, said fifth and sixth walls extending in a direction opposite to the direction in which the third and fourth walls extend.

11. The touch panel display device as claimed in claim 10, further comprising an engaging means for engaging all of said base frame, said upper frame, and said middle frame.

12. The touch panel display device as recited in claim 11, wherein said engaging means has
first plurality of projections extending outwardly from said first and second walls of said base frame respectively,
first plurality of holes penetrating into said first and second walls of said base frame respectively,
second plurality of holes penetrating into said third fourth walls of said upper frame and engaged with said first projections respectively, and
second plurality of projections extending outwardly from said fifth and sixth walls of said middle frame and engaged with said first holes respectively.

13. The touch panel display device as claimed in claim 11, wherein said liquid crystal panel is fixed to said second rim of said middle frame, and said touch panel is fixed to said first rim of said upper frame.

14. The touch panel display device as claimed in claim 12, wherein said fifth wall of said middle frame is positioned between said first wall of said base frame and said third wall of said upper fame, said sixth wall of said middle frame is positioned between said second wall of said base frame and said fourth wall of said upper frame when in assembly.

15. A touch panel display assembly, comprising a first frame including a plurality of side walls, a liquid crystal panel, a second frame for receiving said liquid crystal panel, a third frame defining a space to receive said second frame and adapted for engaging with said first frame, and a touch panel, wherein the first frame is configured to align said touch panel with said first frame by means of at least one protruding element formed on each one of at least two adjacent side walls of said first frame.

16. The touch panel display assembly as claimed in claim 15, wherein a plurality of protruding elements extending from said first frame in a direction opposite to the direction in which said plurality of side walls extend.

17. The touch panel display assembly as claimed in claim 15, wherein at least one projection extends from each one of two adjacent side walls of said first frame, and at least one receiving holes for receiving said at least one projection is defined in each one of two adjacent side walls of said third frame.

18. The touch panel display assembly as claimed in claim 15, wherein said first frame comprises a rim, a plurality of side walls extending downwardly from said rim, and a plurality of protrusion extending upwardly from said rim at each side wall.

19. The touch panel display assembly as claimed in claim 15, wherein said second frame defines at least one second projection extending from each side wall thereof and said third frame has at last one opening defined in each side wall for receiving said at least one projection of said second frame when said second frame is received in said third frame.
